(19) United States
(12) Patent Application Publication
(10) Pub. No.: US 2019/0368885 A1
(43) Pub. Date: Dec. 5, 2019

(54) SYSTEM FOR RIDE SHARING WITH COMMERCIAL TRANSPORT VEHICLES

(71) Applicant: Nissan North America, Inc., Franklin, TN (US)

(72) Inventor: Adrian TAN, Northville, MI (US)

(73) Assignee: Nissan North America, Inc.

(21) Appl. No.: 15/991,723

(22) Filed: May 29, 2018

(51) Int. Cl. G01C 21/34; G06Q 10/04; G06Q 10/06; G06Q 30/06; G01C 21/36

(52) U.S. Cl. CPC G01C 21/3438; G06Q 10/047; G06Q 10/06; G01C 21/3691; G01C 21/3697; G01C 21/3605; G06Q 30/0611

(57) ABSTRACT

A system for ride sharing with commercial transport vehicles, the system includes a receiver, an input device, and an electronic controller. The receiver is configured to receive information regarding a predetermined route for at least one commercial transport vehicle. The input device is configured to enable a user to input information including location and destination. The electronic controller is configured to determine whether the predetermined route for the at least one commercial transport vehicle passes within a predetermined distance from the location and travels in a direction toward the destination, and when the predetermined route for the at least one commercial transport vehicle passes within the predetermined distance from the location and travels in the direction toward the destination, the electronic controller is configured to notify the commercial transport vehicle and the user.

### BACKGROUND

### Field of the Invention

The present invention generally relates to a system for ride sharing with commercial transport vehicles. More specifically, the present invention relates to a system for ride sharing with commercial transport vehicles that connects a rider with a commercial vehicle on a predetermined route.

### Background Information

Conventional transportation, such as buses and trains have fixed schedules and transportation between fixed or predetermined location (e.g., train and bus stations. Additionally, ride sharing through the internet is available from ride share services, and taxi services can dispatch a taxi to a specific location with any desired destination.

### SUMMARY

It has been discovered that to more efficiently travel along some roads, ride sharing a commercial transport vehicle is desired.

In view of the state of the known technology, one aspect of the present disclosure is to provide a system for ride sharing with commercial transport vehicles, the system comprising a receiver, an input device, and an electronic controller. The receiver is configured to receive information regarding a predetermined route for at least one commercial transport vehicle. The input device is configured to enable a user to input information including location and destination. The electronic controller is configured to determine whether the predetermined route for the at least one commercial transport vehicle passes within a predetermined distance from the location and travels in a direction toward the destination, and when the predetermined route for the at least one commercial transport vehicle passes within the predetermined distance from the location and travels in the direction toward the destination, the electronic controller is configured to notify the commercial transport vehicle and the user.

Another aspect of the present disclosure is to provide a method for ride sharing with commercial transport vehicles, the method comprising receiving, via a receiver, information regarding a predetermined route for at least one commercial transport vehicle, inputting, via an input device, information including s location and a destination of a user, determining, via an electronic controller, whether the predetermined route for the at least one commercial transport vehicle passes within a predetermined distance from the location and travels in a direction toward the destination, and when the predetermined route for the at least one commercial transport vehicle passes within the predetermined distance from the location and travels in the direction toward the destination, notifying the commercial transport vehicle and the user.

### BRIEF DESCRIPTION OF THE DRAWINGS

Referring now to the attached drawings which form a part of this original disclosure:

FIG. 1 is a schematic illustration of one embodiment of the present invention;

FIG. 2 is a front view of a device into which user destination and location can be input;

FIG. 3 is a front view of the device of FIG. 2 illustrating the output after ridesharing has been accepted;

FIG. 4 is a view illustrating the starting location, the destination and potential ridesharing commercial transport vehicles;

FIG. 5 is enlarged view of the starting location and the potential ridesharing commercial transport vehicles

FIG. 6 is an enlarged view of the predetermined location for meeting between the user and the commercial transport vehicle; and

FIGS. 7A and 7B are a flow chart illustrating the process of determining a suitable commercial transport vehicle with which to ride share.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

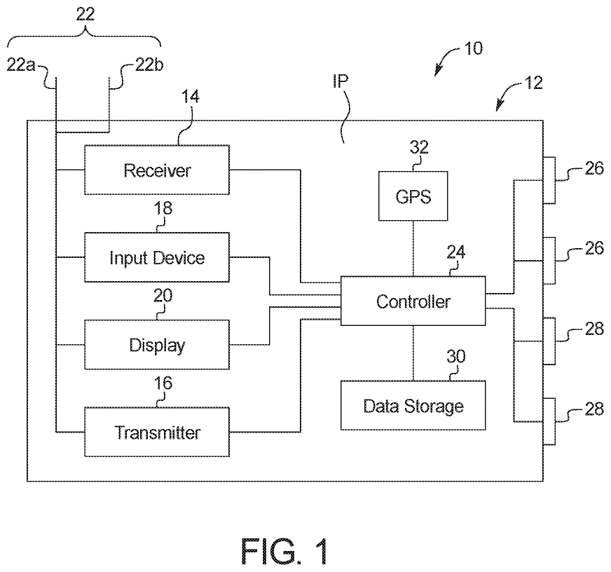

Referring initially to FIG. 1, a system for ride sharing with commercial transport vehicles 10 is illustrated in accordance with a first embodiment. In one embodiment, the system 10 can be a remote communication device, such a portable cellular telephone, a tablet, a computer or any other suitable device. Thus, as discussed herein, the system 10 enables a user to input user location and destination. The system 10 then determines a suitable commercial transport vehicle to transport the user from a location near or at the user location to a location at or near the user destination, based on known commercial transport vehicle routes.

Thus, the system 10 includes a housing 12, a receiver 14, a transmitter 16, an input device 18, a display 20, an antenna system 22 and an electronic controller 24. The system 10 can also include a speaker 26 or speakers 26 for the transmission of sound and a microphone 28 or microphones 28 for the reception of sound. The housing 12 is preferably a plastic or thermoplastic housing 12 or any suitable material of housing 12 the electrical and other components thereof. The housing 12 can be rectangular or any suitable configuration. Moreover, the housing 12 can have a portion thereof for access to the input device 18 and the display 20. Together these elements define an interior portion for the electrical components.

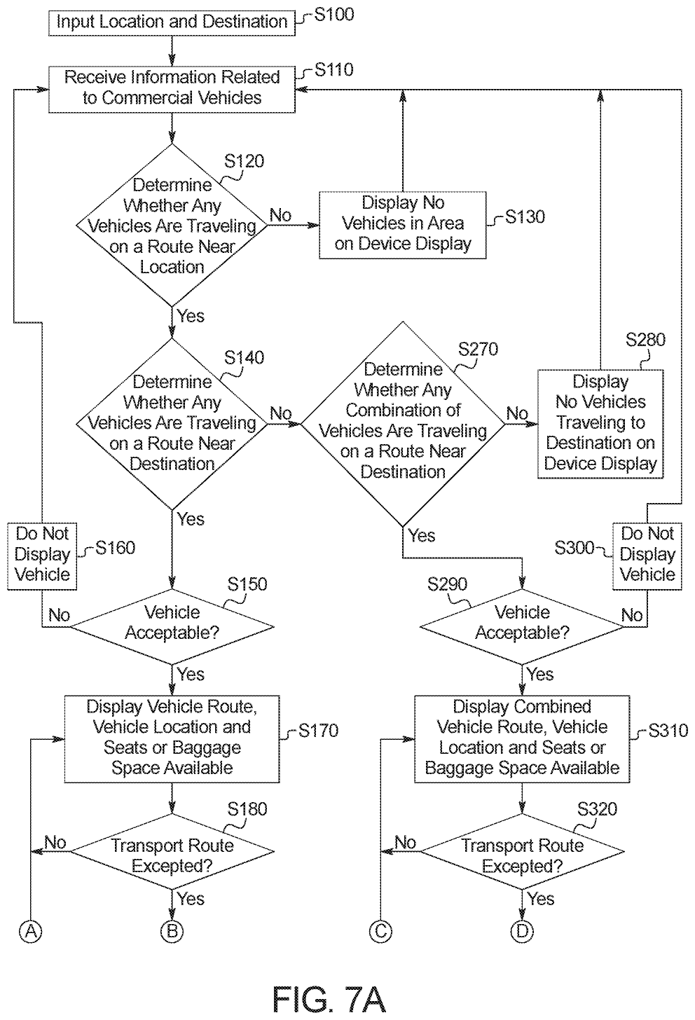

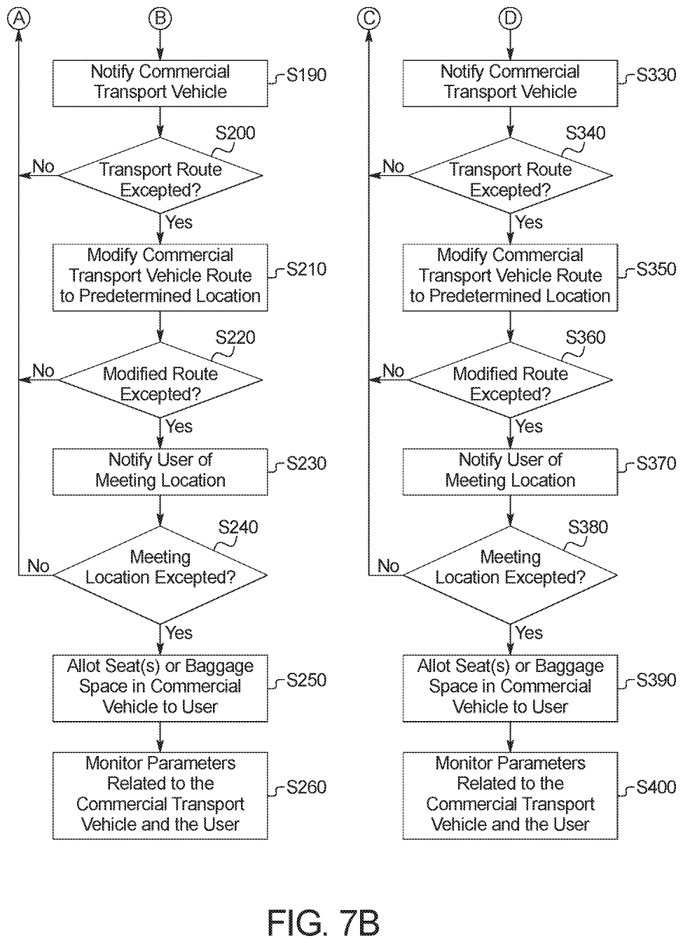

The controller 24 is preferably disposed with the interior portion IP of the housing 12 and is an electronic controller. The controller 24 preferably includes a microcomputer having one or more processors with a control program that controls the components of the system 10 for ride sharing as discussed below. The controller 24 includes other conventional components such as an input interface circuit, an output interface circuit, and a storage device (or devices) 30 such as a ROM (Read Only Memory) device and a RAM (Random Access Memory) device. The microcomputer of the controller 24 is at least programmed to carry out ride sharing in accordance with the flow chart of FIG. 7 as discussed below. It will be apparent to those skilled in the art from this disclosure that the precise structure and algorithms for the controller 24 can be any combination of hardware and software that will carry out the functions of the present invention. Furthermore, the controller 24 can communicate with the other components of the system for ride sharing 10 discussed herein via, for example, a control area network (CAN) bus or in any other suitable manner as understood in the art.

The controller 24 is operatively coupled to the receiver 14, the transmitter 16, the input device 18, the display 20, the data storage, the speaker, the microphone 28, the antenna system 22, and the other types of components in the system 10 in any suitable manner as understood in the art, and is programmed to monitor and control these components as discussed herein. The data storage can also store processing results and control programs that are run by the controller 24, such as processing results and control programs for the receiver 14, the transmitter 16, the input device 18, the display 20, the data storage, the speaker 26, the microphone 28, the antenna system 22 and any other suitable information.

The data storage device 30 is a computer memory device (i.e., a nonvolatile memory device) can store system data, as well as any other suitable data. Furthermore, the data storage device 30 can store other types of data, such as data pertaining to commercial transport vehicle, the locations of the user and the commercial transport vehicle and potential locations for meeting between the two. The data storage device 30 permits a read-out operation of reading out data held in the storage medium in response to an instruction from the controller 24 to, for example, determine commercial transport vehicle location and routes. The information in the data storage device 30 can also be updated by the controller 24 in any suitable manner as discussed herein and as understood in the art.

The system 10 can include a location detection system 32 is configured to determine the location of the system. In one embodiment, the location detection system 32 is a GPS (global positioning system). That is, the location detection system 32 can be a satellite-based radio navigation that enables the system to locate the system.

The microphone 28 is disposed in any suitable place and can be any suitable microphone 28 configured to receive sound. As can be understood, the microphone 28 can receive sound in the form of voice from the user and is in electrical communication with the controller 24. The sound is converted to electrical signals that are then processed by the controller 24 and if desired transmitted by the transmitter 16 and/or stored in the storage device 30.

The speaker 26 is disposed in any suitable place and can be any suitable speaker 26 configured to transmit sound. The speaker 26 is in electrical communication with the controller 24. As can be understood, the speaker 26 can transmit sound in the form of voice to the user, or any other suitable sound as in known in the art. In one embodiment, the speaker can produce an audible sound received by the receiver 14, or an audible sound produced by the controller 24, as one of ordinary skill would understand.

The antenna system 22 can be any suitable antenna system 22 for transmission and reception of a wireless (e.g., cellular) signal. The antenna system 22 can be a single, dual purpose (send and receive) antenna system 22, or there can be two separate antennas. A first antenna system 22a to send signals and a second antenna system 22b to receive signals. As can be understood, the antenna system 22 or antennas can be any suitable antenna or plurality of antennas. The antenna system 22 can receive signals from other devices, computers, or other devices wirelessly. The antenna system 22 can receive signals through a cellular network or directly from another device in any suitable manner.

The input device 18 can be any suitable input device 18, and is in electrical communication with the controller 24. For example, the input device 18 can be a keyboard that enables a user to input information and commands into the system 10. The keyboard K can be an electronic digital keyboard or a physical keyboard with buttons or keys. Additionally, the input device 18 can be voice commands hand or finger commands or stylus or pen input. The display 20 can be any suitable display 20 that would enable any desired or suitable data to be displayed. For example, the display 20 can be a transparent screen that is configured to display the information input by the user or data received by the receiver 14. The display 20 can display map data, and overlay the user location, the location of commercial transport vehicles, a predetermined location or any suitable information.

The receiver 14 and the transmitter 16 can be any suitable receiver 14 and transmitter 16 desired. In one embodiment the receiver 14 and the transmitter 16 are one device (i.e., a transceiver). In another embodiment, the receiver 14 and the transmitter 16 are separate devices. The receiver 14 and transmitter 16 are configured to receive and transmit wireless signals to and from the system 10. The receiver 14 and transmitter 16 are electrically connected the controller 24 and to the antenna system 22. The receiver 14 and transmitter 16 can receive and transmit signals to and from other devices, computers, or other devices wirelessly. The receiver 14 and transmitter 16 can receive and transmit signals through a cellular network or directly from another device through the antenna system 22 in any suitable manner.

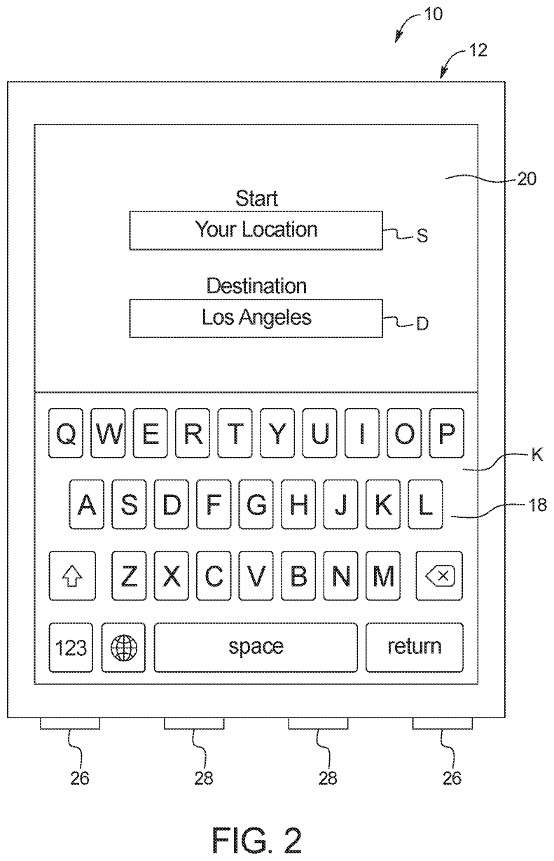

Turning to FIG. 2, the user can input a starting location S and a destination D. The starting location S can be input via the input device 18 or can be determined by the location detection system 32 (e.g., GPS), a triangulation process based on position relative to cellular towers or in any other suitable manner. The destination D can be input via the input device 18 or based on a previous destination or in any suitable manner. The starting location S and the destination D are processed by the controller 24. The controller 24 then determines whether any commercial transport vehicles CTV are in the vicinity of the starting location S, each of the commercial transport vehicles CTV predetermined route PR and each of the commercial transport vehicles final destination FD and/or any intermediary destinations. ID This information related to the commercial transport vehicles CTV can be obtained in any suitable manner. For example, in one embodiment, commercial transport vehicles information is uploaded by each commercial transport vehicle CTV and stored in a remote server. The system 10 communicates with the server via the transmitter 16 and requests information related to commercial transport vehicles CTV with predetermined routes PR relevant to the user starting location S. The information is sent to and received by the receiver 14. In another embodiment, the system 10 sends a signal requesting this information directly from the commercial transport vehicles CTV within a predetermined area directly. The information related to each commercial transport vehicle starting location S is then directly transmitted to and received by the receiver 14 in the system 10. The system 10 can receive this information in any suitable manner or combination of manners.

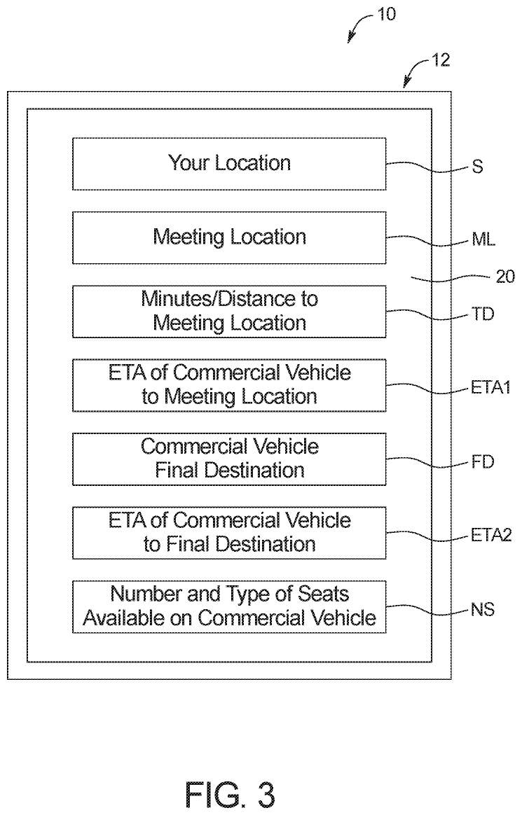

The controller 24 then displays the relevant information on the display 20, as shown in FIG. 3. For example, the controller 24 can cause the display 20 to display the users location (i.e., starting location S), the meeting location ML, the time/distance TD to the meeting location ML, the estimated time of arrival ETA1 of the commercial transport vehicle CTV to the meeting location ML, the final destination FD (and/or any intermediary destinations ID), the estimated time of arrival ETA2 of the commercial transport vehicle CTV to the final destination FD, and the number/types of seats and/or baggage space NS available of the commercial transport vehicle CTV. The controller 24 can cause the display 20 to display this information for one commercial transport vehicle CTV or a plurality of commercial transport vehicles CTV.

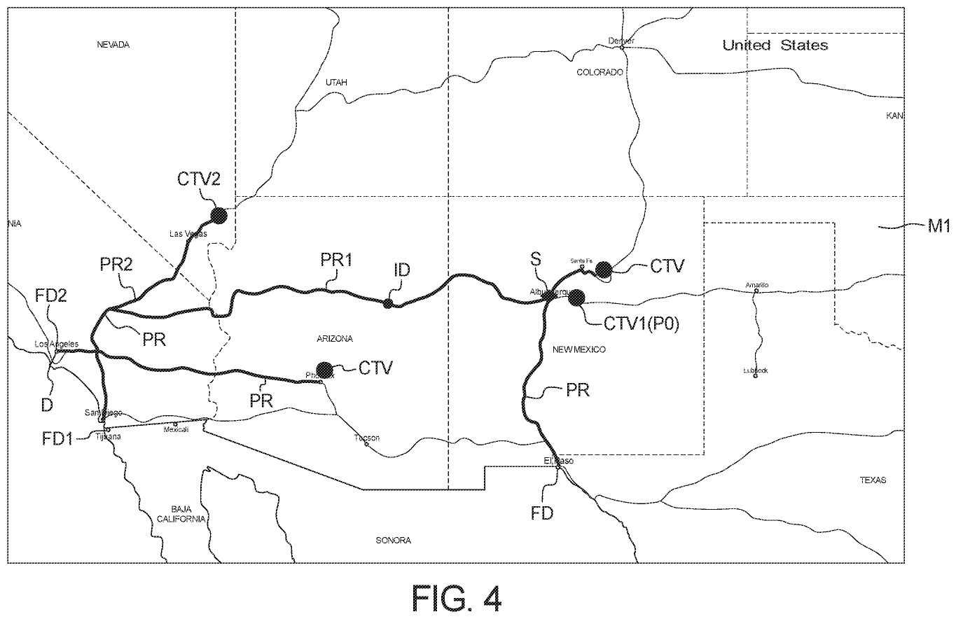

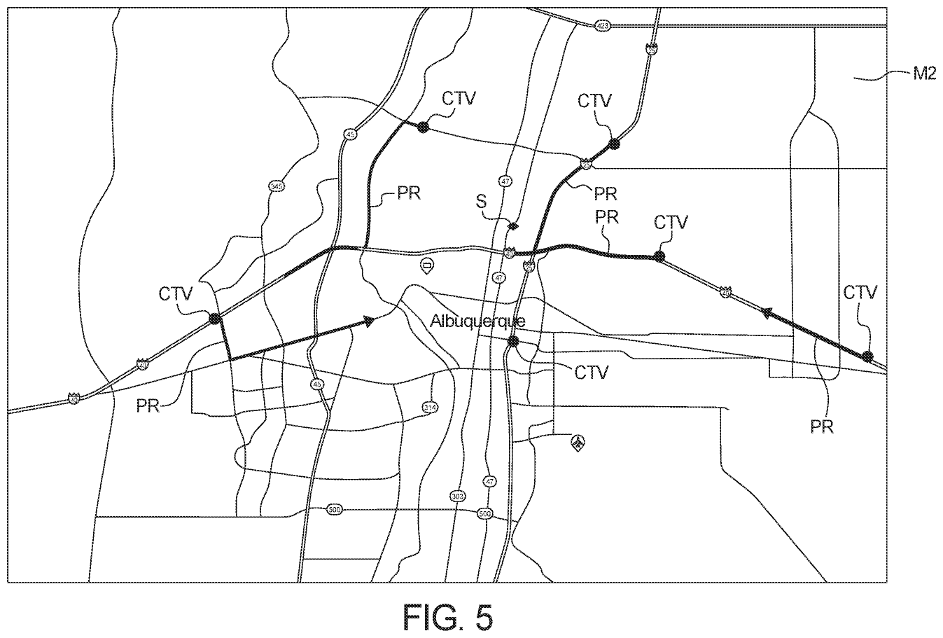

Additionally, as shown in FIG. 4, the controller 24 can cause the display 20 to display a map M1 showing all available commercial transport vehicle vehicles on route to an area near the user (e.g., starting location S), each of the predetermined routes PR for the commercial transport vehicles CTV and each of the commercial transport vehicles final destination FD along with the user's destination D. Thus, the user is capable of selecting among a plurality of commercial transport vehicles CTV which vehicle is most desirous. The user is also capable of “zooming” in on the map (map M2) to view the commercial transport vehicle CTV in a closer vicinity to determine whether any of the commercial transport vehicles pass in a location of close proximity to the user e.g., starting location S), as shown in FIG. 5.

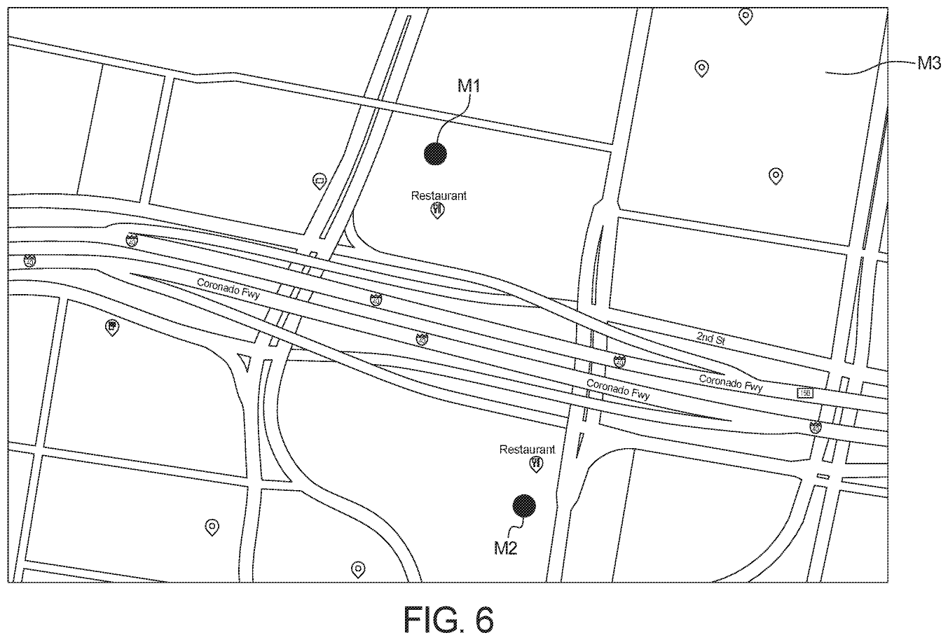

The user is able to view meeting locations ML on a map, as shown in FIG. 6. The meeting locations ML can be predetermined locations within the area. For example, multiple meeting locations ML1 and ML2 can be shown for selection by the user. The meeting locations ML1 and ML2 can be rest stops, gas stations, parking lots or commercial transport vehicle ride sharing locations. Moreover, the meeting locations ML can be any suitable public or private location.

Thus, as can be understood, once the user inputs relevant information regarding a request to travel from a starting location S to a destination D, the controller 24 receives information regarding possible commercial transport vehicles CTV options. Generally, this information relates to the type of vehicle, the number of seats and/or baggage space available NS, the final destination FD and the meeting location ML for each commercial transport vehicle CTV. One or a plurality of transports options are selected by the controller 24 and caused to be displayed on the display 20 by the controller 24. The user then has the option of selecting or rejecting any of the options using the input device 18. Once a selection has been made by the user, the controller 24 causes this information to be transmitted to the relevant commercial transport vehicle CTV.

The controller 24 causes the transmitter 16 to transmit relevant information about the user and the proposed trip to the commercial transport vehicle CTV. For example, the information can include, the user location (i.e., starting location S), the meeting location ML, the destination D and any other relevant information. The commercial transport vehicle CTV and/or the commercial transport vehicle operator have the option of rejecting the user for any suitable reason. For example, the commercial transport vehicle CTV and/or the commercial transport vehicle operator may determine that the meeting location ML or the destination D are not viable due to distance from the predetermined route PR, time off route, route time requirements, or the commercial transport vehicle load being not suitable for transport with a third party. If the commercial transport vehicle CTV and/or the commercial transport vehicle operator rejects the user, the user is offered another option from the plurality of commercial transport vehicles CTV.

If the commercial transport vehicle CTV and/or the commercial transport vehicle operator accepts the user, the commercial transport vehicle CTV is diverted or given instructions to divert to the meeting location ML by the controller 24.

It is noted that the controller 24 may determine that multiple commercial transport vehicles CTV are required to transport the user from the starting location S to the destination D. In such a situation, the controller 24 is configured to determine the predetermined routes PR for a plurality of commercial transport vehicles CTV and coordinate pick up and drop off (PD) between the multiple commercial transport vehicles (see for example FIG. 4). In other words, a first commercial transport vehicle CTV1 on a first predetermined route PR1 of a first final destination FD1 is determined to be capable of picking up the user at a meeting location ML in the vicinity of the user (i.e., near the starting location S). The controller 24 is further configured to determine that the first commercial transport vehicle, although not traveling to the user's destination D, intercepts (creating a pick up and drop off (PD)) a route of a second commercial transport vehicle CTV2 that is not in the vicinity of the user or otherwise not in a convenient location or within a convenient time to pick up the user at the meeting location ML, but is traveling along a second predetermined route PR2 to a second final destination FD2 that is the user's destination D. The controller 24 is configured to communicate the possibility of the multiple commercial transport vehicle route (PR1/PR2) to the user. The user can then accept or reject the multiple commercial transport vehicle route (PR1/PR2). Once the user accepts the multiple commercial transport vehicle route (PR1/PR2), this information is sent to the first and second commercial transport vehicles CTV1 and CTV2. These vehicles can then accept or reject the user for the reasons described above, or any other suitable reason.

As can be understood, the time between the first and second commercial transport vehicles CTV1 and CTV2 can be any suitable time and the user can select to stay at intermediary destinations (e.g. pick up and drop off (PD)) for any suitable or desired time. In other words, the second commercial transport vehicle CTV2 may be passing through the pick up and drop off (PD) at any time, within a few minutes or within a few days of the first commercial transport vehicle CTV1. If the time between the second commercial transport vehicle CTV2 and the first commercial transport vehicle CTV1 passing through the pick up and drop off (PD) is hours or days, the user can still select this option and choose to stay at the pick up and drop off (PD). In one embodiment the system can suggest hotels or other accommodations within the pick up and drop off (PD). Moreover, the multiple commercial transport vehicle route can be any number of commercial transport vehicles.

Turning to FIGS. 7A and 7B, a method of for ride sharing with commercial transport vehicles is illustrated. First in step S100, the user inputs location (or route starting point) and destination into the system 10 using the input device 18. Alternatively, the system 10 can determine location based on GPS location, triangulation or in any suitable manner. The controller 24, via the transmitter 16 and receiver 14, then requests and receives information related to commercial transport vehicles CVT in step S110. The information can include any relevant information, including but not limited to, commercial transport vehicle location, commercial transport vehicle destination FD, seat and/or baggage space availability NS, load contents (if any) and any other information related to the commercial transport vehicle or the operator. The information can include the schedule of the commercial transport vehicle CVT (is the vehicle late, early on time), or is the cargo conducive to a rider (does it smell, is it dangerous, etc.). Moreover, the information can include information on whether the commercial transport vehicle CVT is part of a preferred operator PO (either indicated by the user or a national rating). In some embodiments, the information can include past ride sharing information including ratings, timeliness of past ride share completions, comments from previous riders, any other information described herein or any other information that would facilitate a decision on whether the user wanted to select the commercial transport vehicle. In one embodiment, the user can select or input parameters that the controller 24 can cause to be requested. The parameters can be any of the herein described pieces of information. For example, the user can input parameters that only preferred operators are desired or that vehicles hauling certain loads are not desired.

The controller 24 then determines whether any of the commercial transport vehicles CTV are traveling on a predetermined route PR that passes near the location of the user (or the starting location S) in step S120. If no commercial transport vehicles CTV are traveling on a route near the location of the user (or the starting location S), the controller 24 causes the display 20 to display no vehicles in area (or any other suitable display) in step S30 and attempts to receive additional information related to commercial transport vehicles CTV.

If the controller 24 determines that at least one commercial transport vehicle CTV is traveling on a predetermined route PR that passes near the location of the user (e.g., starting location S), the controller 24, in step S140 it is then determined whether any of the at least one commercial transport vehicles CTV are traveling on a predetermined route PR that arrives at or passes near or ends at the users input destination D. If the controller 24 determines that at least one of the commercial transport vehicle CTV is traveling on a predetermined route PR that passes near the location of the user (e.g., starting location S) and is also traveling on a predetermined route PR that arrives at or passes near the users input destination D, the controller 24, in step S150, determines if the commercial transport vehicle CTV or commercial transport vehicle operator is acceptable. For example, based on the information, i.e., whether the commercial transport vehicle CTV is late, or if the cargo is not conducive (smells, dangerous, etc.) to ride sharing, or if the commercial transport vehicle CTV is not a preferred company or has a low rating, the controller 24 can determine that the commercial transport vehicle CTV is not acceptable. If the controller 24 determines that the commercial transport vehicle CTV is not acceptable it is not displayed on the display 20 in step S160 and the controller 24 attempts to receive additional information related to commercial transport vehicles CTV. The information that the controller 24 uses to determine whether the commercial transport vehicle CTV or commercial transport vehicle operator is acceptable can be input into the system 10 by the user and stored in the storage device 30. Alternatively, the information the controller 24 uses to determine if the commercial transport vehicle CTV or commercial transport vehicle operator is acceptable can be programmed into the system 10.

Once the controller 24 determines that one or more of the commercial transport vehicles CTV is acceptable, the controller 24 causes the display 20 to display the vehicle, the vehicle route, the vehicle location, the meeting location and the seats and/or baggage space available in step S170. The controller 24 can cause additional or less information to be displayed. Moreover, as described above, this information can be displayed in a list form or in a map form or any combination thereof, or in any suitable manner that would sufficiently convey relevant information to the user.

In step S180, the controller 24 determines whether the predetermined route PR and meeting location ML are accepted by the user. If the predetermined route PR is not accepted by the user, the controller 24 causes the display 20 to display another commercial transport vehicle CTV, the predetermined route PR, the vehicle location, the meeting location ML and the seats and/or baggage space available NS in step S170. If the predetermined route PR and meeting location ML are accepted by the user, the controller 24 causes the transmitter 16 to transmit and notify the commercial transport vehicle CTV of the user's acceptance and user information in step S190. For example, the controller 24 can cause the transmitter 16 to transmit the information about the user (e.g., reliability rating, previous ride information, location, etc.).

In step S2000, the controller 24 receives, via the receiver 14, information whether the transport vehicle has accepted the user on the transport route. In other words, has the commercial transport vehicle CTV accepted the user request to ride share. If the commercial transport vehicle CTV does not accept the user request to ride share, the controller 24 causes the display 20 to display another commercial transport vehicle CTV, the predetermined route PR, the vehicle location, the meeting location ML and the seats and/or baggage space available NS in step S170. If the commercial transport vehicle CTV does accept the user request to ride share, the controller 24 modifies the commercial transport vehicle's route to the meeting location ML and causes the transmitter 16 to transmit information marking the seat or seat in the commercial transport vehicle's system as taken or occupied in step S210.

In step S220, the controller 24 is configured to receive information via the receiver 14 whether the commercial transport vehicle CTV has accepted the modified route to the meeting location ML. In other words, the commercial transport vehicle CTV, upon being notified of the route modification to the meeting location ML, can decide to reject the request to ride share. If the commercial transport vehicle CTV does not accept the user request to ride share, the controller 24 causes the display 20 to display another commercial transport vehicle CTV, the predetermined route PR, the vehicle location, the meeting location ML and the seats and/or baggage space available NS in step S170. If the commercial transport vehicle CTV does accept the user request to ride share, the controller 24 notifies the user of the meeting location ML, commercial transport vehicle's reliability rating and estimated time of arrival ETA1 at the meeting location ML of the commercial transport vehicle CTV in step S230.

In step S240, the controller 24 determines whether the user has accepted the meeting location ML. If the user has not accepted the meeting location ML, the controller 24 causes the transmitter 16 to transmit and notify the commercial transport vehicle CTV, cancelling the ride sharing request and uses the display 20 to display another the commercial transport vehicle CTV, the predetermined route PR, the vehicle location, the meeting location ML and the seats and/or baggage space available NS in step S170. If the user has accepted the meeting location ML, the controller 24 causes transmitter 16 to transmit a confirmation of the allotment of the seat or the plurality of seats or part or all of the baggage space available in the commercial transport vehicle to the user in step S250. The controller 24, in step S260, monitors and displays the progress of the commercial transport vehicle CTV through the destination D. Additionally, the controller 24 causes information related to the user and the commercial transport vehicle CTV to be stored in the storage device 30. This information can be related to reliability rating or any other information. For example, the information can be related to the speed of the commercial transport vehicle STV, rating provided by the user and/or commercial transport vehicle CTV, and any other relevant information.

Turning back to step S140, if the controller 24 determines that none of the commercial transport vehicle's CTV traveling on a route that passes near the location of the user (e.g., the staring location S) is also traveling on a predetermined route PR that arrives at or passes near the users input destination D, the controller 24, in step S270 determines whether a combination of commercial transport vehicles CTV are traveling on a predetermined route PR near the user's destination D. That is, controller 24 can determine that multiple commercial transport vehicles CTV are required to transport the user from the starting location S to the destination D. In such a situation, the controller 24 is configured to determine the predetermined routes PR for a plurality of commercial transport vehicles CTV and coordinate pick up and drop off PD between the multiple commercial transport vehicles CTV. In other words, the first commercial transport vehicle CTV1 traveling along the first predetermined route PR1 is determined to be capable of picking up the user at a meeting location ML in the vicinity of the user. The controller 24 is further configured to determine that the first commercial transport vehicle CTV1, although not traveling to the user's destination D, intercepts a second predetermined route PR2 of a second commercial transport vehicle CTV2 that is not in the vicinity of the user or otherwise not in a convenient location or within a convenient time to pick up the user, but is traveling to or near the user's destination D.

If the controller 24 determines that no combination of commercial transport vehicles CTV are traveling on a route near the user's destination, in step S280, the controller 24 causes the display 20 to display that no commercial transport vehicles are traveling to the destination. The controller 24 then requests and receives additional information related to commercial transport vehicles in step S110.

If the controller 24 determines that a combination of commercial transport vehicles CTV are traveling on a route neat the user's destination, in step S290, the controller 24 determines if each of the commercial transport vehicles CTV or commercial transport vehicle operators is acceptable. For example, based on the information, i.e., whether the commercial transport vehicle is late, or if the cargo is not conducive (smells, dangerous, etc.) to ride sharing, or if the commercial transport vehicle is not a preferred company or has a low rating, the controller 24 can determine that at least one of the commercial transport vehicles is not acceptable. If the controller 24 determines that at least one of the commercial transport vehicles is not acceptable the unacceptable commercial transport vehicle is not displayed on the display 20 in step S300 and the controller 24 attempts to receive additional information related to commercial transport vehicles CTV. The information that the controller 24 uses to determine whether the commercial transport vehicle CTV or commercial transport vehicle operator is acceptable can be input into the system 10 by the user and stored in the storage device 30. For example, the user can determine that certain operating companies are unacceptable or certain loads are unacceptable. This information and any other information can be stored in the storage device 30. Alternatively, the information the controller 24 uses to determine if the commercial transport vehicle or commercial transport vehicle operator is acceptable can be programmed into the system 10.

Once the controller 24 determines that one or more combinations of commercial transport vehicles CTV is acceptable, the controller 24 causes the display 20 to display the commercial transport vehicles CTV, the combined predetermined routes PR1 and PR2, the vehicle locations, the meeting location ML and the seats and/or baggage space available NS in each commercial transport vehicle CTV in step S310. The controller 24 can cause additional or less information to be displayed. Moreover, as described above, this information can be displayed in a list form or in a map form or any combination thereof, or in any suitable manner that would sufficiently convey relevant information to the user.

In step S320, the controller 24 determines whether the predetermined routes PR1 and PR2, the pick up and drop off PD, the meeting location ML, and seats and/or baggage space available NS are accepted by the user. If the predetermined routes PR1 and PR2, the pick up and drop off PD, the meeting location ML, and seats a and/or baggage space available NS are not accepted by the user, the controller 24 causes the display 20 to display another combination of commercial transport vehicles CTV, the combined predetermined routes PR, the vehicle locations, the meeting location the pick up and drop off PD, meeting location ML, and the seats and/or baggage space available NS in each commercial transport vehicle CTV in step S310. If the combined predetermined routes PR, the vehicle locations, the meeting location the pick up and drop off PD, meeting location ML, and the seats available and/or baggage space NS are accepted by the user, the controller 24 causes the transmitter 16 to transmit and notify each the commercial transport vehicles CTV1 and CTV2 of the user's acceptance and user information in step S330. For example, the controller 24 can cause the transmitter 16 to transmit the information about the user (e.g., reliability rating, previous ride information, location, etc.).

In step S340, the controller 24 receives, via the receiver 14, information whether the commercial transport vehicles CTV1 and CTV2 have accepted the user on the predetermined routes PR1 and PR2. In other words, have the commercial transport vehicles CTV1 and CTV2 accepted the user request to ride share. If each of the commercial transport vehicles CTV1 and CTV2 do not accept the user request to ride share, the controller 24 causes the display 20 to display another combination of commercial transport vehicles CTV1 and CTV2, the predetermined routes PR1 and PR2, the pick up and drop off PD, the meeting location ML, and seats and/or baggage space available NS in each commercial transport vehicle CTV in step S310. If each of the commercial transport vehicles CTV1 and CTV2 does accept the user request to ride share, the controller 24 modifies the first commercial transport vehicle CTV1 route to the meeting location ML, modifies each of the subsequent commercial transport vehicles (e.g., a second commercial transport vehicle CTV2) routes so as to meet at a meeting location (e.g., a pick up and drop off PD) and causes the transmitter 16 to transmit information marking the seat or seats and/or baggage space NS in each of the commercial transport vehicle's systems as taken or occupied in step S350.

In step S360, the controller 24 is configured to receive information via the receiver 14 whether the commercial transport vehicles CTV1 and CTV2 have accepted the modified routes to the meeting location ML and the pick up and drop off PD. In other words, the commercial transport vehicles CTV1 and CTV2, upon being notified of the route modifications to the meeting location ML and the pick up and drop off PD, can decide to reject the request to ride share. If one of the commercial transport vehicles CTV1 or CTV2 does not accept the user request to ride share, the controller 24 causes the display 20 to display another combination of commercial transport vehicles CTV, the combined predetermined routes PR, the vehicle locations, the meeting location the pick up and drop off PD, meeting location M L, and the seats and/or baggage space available NS in each commercial transport vehicle in step S310. If each of the commercial transport vehicles CTV1 and CTV2 does accept the user request to ride share, the controller 24 notifies the user of the meeting location ML and subsequent pick up and drop off PD locations, each of the vehicle's reliability rating and estimated time of arrival ETA1 at the meeting location ML and subsequent pick up and drop off PD locations for each of the commercial transport vehicles in step S370.

In step S380, the controller 24 determines whether the user has accepted the predetermined meeting location ML and subsequent pick up and drop off PD locations for each of the commercial transport vehicles CTV1 and CTV2. If the user has not accepted the meeting location ML and pick up and drop off PD locations for each of the commercial transport vehicles CTV1 and CTV2, the controller 24 causes the transmitter 16 to notify the commercial transport vehicles CTV1 and CTV2, cancelling the ride sharing request and causes the display 20 to display another combination of commercial transport vehicles CTV, the combined predetermined routes PR, the vehicle locations, the meeting location the pick up and drop off PD, meeting location ML, and the seats and/or baggage space available NS in each commercial transport vehicle in step S310. If the user has accepted the meeting location ML and pick up and drop off PD locations for each of the commercial transport vehicles CTV1 and CTV2, the controller 24 causes the transmitter 16 to cause confirmation of the allotment of the seats and/or part of the baggage space or the plurality of seats and/or or part or all of the baggage space NS in each of the commercial transport vehicles CTV1 and CTV2 to the user in step S390. The controller 24, in step S400, monitors and displays the progress of the commercial transport vehicles CTV1 and CTV2 through the destination. Additionally, the controller 24 causes information related to the user and the commercial transport vehicles CTV1 and CTV2 to be stored in the storage device 30. This information can be related to reliability rating or any other information. For example, the information can be related to the speed of the commercial transport vehicles, ratings provided by the user and/or commercial transport vehicle, and any other relevant information.

It is noted that the combined vehicles routes are not limited to two commercial transport vehicles, but can include any number of suitable commercial transport vehicles that would enable a user to travel from the starting location S to the destination D. Moreover, the user can modify the destination D at any time including during travel in a attempt to arrive at a more desired or different location. Further, the methods and systems described herein are capable of being used with commercial transport vehicles or any other suitable vehicles that are driver by an operator or autonomous.

The receiver 14, transmitter 16, input device 18, display 20, and antenna system 22 are conventional components that are well known in the art. Since receiver 14, transmitter 16, input device 18, display 20, and antenna system 22 are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” or “element” when used in the singular can have the dual meaning of a single part or a plurality of parts. Accordingly, these terms, as utilized to describe the present invention should be interpreted relative to a system for ride sharing with commercial transport vehicles.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for ride, sharing with commercial transport vehicles, the system comprising:
a receiver configured to receive information regarding a predetermined route for at least one commercial transport vehicle;
an input device configured to enable a user to input information including location and destination; and
an electronic controller configured to determine whether the predetermined route for the at least one commercial transport vehicle passes within a predetermined distance from the location and travels in a direction toward the destination, and when the predetermined route for the at least one commercial transport vehicle passes within the predetermined distance from the location and travels in the direction toward the destination, the electronic controller is configured to notify the commercial transport vehicle and the user.

2. The system according to claim 1, wherein
the receiver is configured to receive information regarding a plurality of commercial transport vehicles, and the electronic controller is configured to determine whether each of the plurality of commercial transport vehicles passes within the predetermined distance from the location and travels in the direction toward the destination.

3. The system according to claim 1, wherein
the electronic controller is configured to determine whether the predetermined route of a first commercial transport vehicle of the at least one commercial transport vehicle passes within a predetermined distance from the location and travels in the direction toward the destination, whether a second commercial transport vehicle of the at least one commercial transport vehicle travels in the direction toward the destination, and whether the predetermined route of the first commercial transport vehicle and the predetermined route of the second commercial transport vehicle intersect.

4. The system according to claim 1, wherein
the electronic controller is configured to notify the at least one commercial transport vehicle of a predetermined location in the vicinity of the location of the user.

5. The system according to claim 1, wherein
the electronic controller is configured to modify the predetermined route based on the destination of the user or the location of the user.

6. The system according to claim 5, wherein
when the predetermined route has been modified, the electronic controller is configured to cancel the information regarding the at least one commercial transport vehicle.

7. The system according to claim 1, wherein
the electronic controller is configured to monitor the number and type of seats or baggage space available M the commercial transport vehicle.

8. The system according to claim 7, wherein
the electronic controller is configured allot at least one seat available in the commercial transport vehicle to the user based on the information input with the input device.

9. The system according to claim 1, wherein
the electronic, controller is configured to monitor parameters related to the commercial transport vehicle and the user, and based on the parameters rate the reliability thereof.

10. A method for ride sharing with commercial transport vehicles, the method comprising:
receiving, via a receiver, information regarding a predetermined route for at least one commercial transport vehicle;
inputting, via an input device, information including s location and a destination of a user;
determining, via an electronic controller, whether the predetermined route for the at least one commercial transport vehicle passes within a predetermined distance from the location and travels in a direction toward the destination; and
when the predetermined route for the at least one commercial transport vehicle passes within the predetermined distance from the location and travels in the direction toward the destination, notifying the commercial transport vehicle and the user.

11. The method according to claim 10, further comprising
receiving, via the receiver, information regarding a plurality of commercial transport vehicles, and determining, via the electronic controller whether each of the plurality of commercial transport vehicles passes within the predetermined distance from the location and travels in the direction toward the destination.

12. The method according to claim 10, further comprising
determining, via the electronic controller, whether the predetermined route of a first commercial transport vehicle of the at least one commercial transport vehicle passes within a predetermined distance from the location and travels in the direction toward the destination, whether a second commercial transport vehicle of the at least one commercial transport vehicle travels in the direction toward the destination, and whether the predetermined route of the first commercial transport vehicle and the predetermined route of the second commercial transport vehicle intersect.

13. The method according to claim 10, further comprising
notifying the at least one commercial transport vehicle of a predetermined location in the vicinity of the location of the user.

14. The method according to claim 10, wherein
modifying, via the electronic controller, the predetermined route based on the destination of the user or the location of the user.

15. The method according to claim 14, wherein
when the predetermined route has been modified, canceling the information regarding the at least one commercial transport vehicle.

16. The method according to claim 10, wherein
monitoring, via the electronic controller, the number and type of seats or baggage space available in the commercial transport vehicle.

17. The method according to claim 16, wherein
allotting at least one seat available and at least a part of the baggage space available in the commercial transport vehicle to the user based on the information input with the input device.

18. The method according to claim 10, wherein
monitoring, via the electronic controller, parameters related to the commercial transport vehicle and the user, and based on the parameters rating the reliability thereof.
